(19) United States
(12) Patent Application Publication
(10) Pub. No.: US 2005/0031094 A1
(43) Pub. Date: Feb. 10, 2005

(54) System and method for message delivery to a busy called party

(76) Inventor: Quenton L. Gilbert, Atlanta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/824,208

(22) Filed: Apr. 14, 2004

Related U.S. Application Data
(63) Continuation-in-part of application No. 10/251,233, filed on Sep. 19, 2002.

(51) Int. Cl. H04M 11/00; H04M 1/64

(52) U.S. Cl. 379/88.14; 379/88.13

(57) ABSTRACT

A method of routing a text message to a second destination associated with a called party where a first destination is unavailable is disclosed. The method comprises the step of receiving a call to a first destination associated with a called party initiated by a calling party, wherein the first destination is unavailable. Due to the unavailability of the first destination, a voice message is received from the calling party. The voice message is then converted to a text message and forwarded to the second destination associated with the called party.

### TECHNICAL FIELD

This invention relates to the field of telecommunications, and more specifically, to routing a text message to one or more alternate destinations associated with a called party.

### BACKGROUND

More and more people are using multiple telephone numbers for both personal and business purposes. For example, many people have different telephone numbers for their residence, office, facsimile machine, cellular telephone, pager, personal digital assistant, modem, electronic mail device, and voicemail. With so many different telephone numbers, it is no wonder that people often have to call several different numbers before reaching their desired party.

Accordingly, if the desired party is not at the location associated with the called telephone number, the call may go unanswered. Moreover, even if the desired party is at that location, the telephone line may be busy due to, for example, an extended voice or data connection. In these and other similar cases, the caller may wish to transmit a priority message to a device that the desired party would promptly receive and examine. For instance, where the desired party routinely checks an electronic mail device or facsimile machine, a message sent to either will likely be received by the desired party, regardless of whether the party is away from the location of the original call or otherwise unavailable.

Transmitting an electronic mail or facsimile message, however, generally requires additional time and resources such as, accessing a computer or facsimile machine and writing or typing a text message. This may be inconvenient for many callers, especially if they cannot readily access such devices. Moreover, the calling party may not know, may have forgotten, or misplaced the number or address of those devices.

For these and other reasons, a need exists for a method and system that will permit a calling party to record a voice message, convert the voice message into a text message, and have that message transmitted to an alternate destination associated with a called party.

### SUMMARY OF THE INVENTION

In accordance with an aspect of the present invention, a method of routing a text message to a second destination associated with a called party where a first destination is unavailable is disclosed. The method comprises the step of receiving a call to a first destination associated with a called party initiated by a calling party, wherein the first destination is unavailable. Due to the unavailability of the first destination, a voice message is received from the calling party. The voice message is then converted to a text message and forwarded to the second destination associated with the called party.

In another aspect of the present invention, a system for routing a text message to a second destination associated with a called party where a first destination is unavailable is disclosed. The system comprises a first switch for receiving a call to a first destination associated with a called party initiated by a calling party, wherein the first destination is unavailable. The system further comprises a network element, coupled to the first switch, for requesting a voice message from the calling party based on the unavailability of the first destination and for receiving a voice message provided by the calling party. A voice recognition means, coupled to the network element, converts the voice message to a text message. In addition, a second switch, coupled to the network element, is provided, wherein the network element forwards the text message to the second destination associated with the called party via the second switch.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention.

FIG. 1 illustrates a diagram of a portion of a public switched telecommunications network in an exemplary embodiment consistent with the present invention.

FIG. 2 illustrates a flow chart of a method for routing a text message to a second destination associated with a called party in an exemplary embodiment consistent with the present invention.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

The present invention is directed to a system and method for routing a call placed to a particular terminating device associated with a called party to an alternate destination also associated with the called party. Such devices may include landline and cellular telephones, computers, paging devices, facsimile machines, modems, and other similar devices. In one exemplary embodiment of the present invention, the called party previously provides at least one alternate destination to route a text message. If the called party's telephone line is unavailable, the calling party is given an option to record a voice message, have the message converted into text, and sent to one or more of the provided alternate destinations.

In another exemplary embodiment of the present invention, the called party does not previously provide at least one alternate destination. If the called party's telephone line is unavailable, the calling party is given an option to select an alternate destination by entering the routing information associated with those selected destinations.

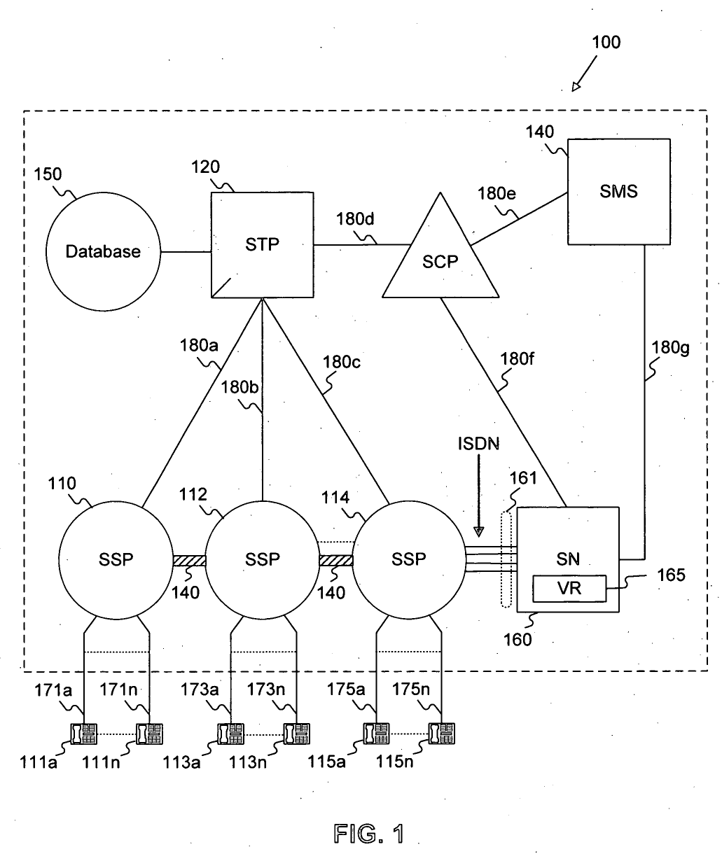

FIG. 1 illustrates a block diagram of an exemplary intelligent switched telecommunications network 100 in accordance with methods and systems consistent with the invention. The blocks illustrated in FIG. 1 may be implemented in a variety of hardware, both analog and digital, and software aspects, known to those skilled in the art. As known to those skilled in the art, these quantities take the form of electrical, magnetic, or optical signals capable of being stored, transferred, combined, and otherwise manipulated through mechanical and electrical components of a computer system; and the computer system includes general purpose, as well as special purpose, data processing machines, systems, and the like, that are standalone, adjunct, or embedded.

Referring to FIG. 1, a portion of a public switched telecommunications network (“PSTN”) including an Advanced Intelligent Network (“AIN”) 100 of a typical local exchange carrier (“LEC”) is shown. In accordance with exemplary embodiments of the present invention, the AIN 100, which is well known to those skilled in the art, is the operating environment of the exemplary embodiments of the present invention. Those skilled in the art will appreciate that other networks, such as Voice over Internet Protocol (“VoIP”) networks could also be utilized.

The AIN 100 generally includes a plurality of central office switches with some of the central office switches equipped with service switching points (“SSPs”). An SSP (e.g., a 5ESS, DMS, or 1AESS type central office switch) is the AIN component of a typical electronic central office switch used by a local exchange carrier. The terms “SSP” and “switch” are used interchangeably to refer to a telecommunications switch for connecting voice channel circuits, including voice channel lines, commonly designated as 171, 173, and 175.

Each SSP in the AIN 100 “services,” or serves, as an originating switch for a number of telephone lines. Generally, an originating switch is directly connected with the telephone lines serviced by the switch. Thus, the originating switch that services a calling party's line is usually the first network element of the AIN 100 to process communications originating on the calling party's line. The originating switch receives a communication originating on this line and implements further processing, such as routing the communication for connection with a terminating destination. For example, an SSP 110 may receive a communication from an originating station, such as telephone 111a, on a telephone line 171a and route the communication for connection with a terminating destination 115n in accordance with the packet-switched protocol of the PSTN. The details of communication routing are familiar to those skilled in the art.

The switches of the AIN 100 are interconnected by a network of voice channel lines known as “trunks” designated as 140 in FIG. 1. Trunks are the voice channel circuits that interconnect the central office switches to connect voice-channel communications. The term “communication” includes all messages or communications that may be exchanged between two pieces of terminating equipment. In FIG. 1, the terminating equipment is represented by telephones that are commonly designated as 111, 113, and 115.

As shown, FIG. 1 illustrates a conventional landline telecommunications system. It should be understood, however, that alternative embodiments of the present invention might operate in association with cellular or other wireless telecommunications systems. Accordingly, although the terminating equipment is illustrated as landline telephones, those skilled in the art will understand that terminating equipment may include both wireless and landline communication devices, such as wireless telephones, facsimile machines, personal digital assistants, modems, and the like.

Each piece of terminating equipment in the PSTN is generally assigned a directory number. The term “directory number” is used herein in a manner consistent with its generally understood meaning of a number that is dialed or input by an calling party at an originating station to reach a terminating destination associated with the directory number. A directory number, typically a seven or ten-digit number, is commonly referred to as a “telephone number” and may be assigned to a specific telephone line, such as the telephone line 171a shown in FIG. 1.

Routing a communication from the originating station 111a to the terminating destination 115n involves the selection of a routing path for the communication and may also involve the implementation of one or more advanced network functions, such as call forwarding, calling party identification, prepaid or debit-card communication services, and the like. The ability of a typical SSP to provide these advanced network functions, however, is limited due to physical and other constraints. The AIN 100 therefore provides for increased information processing capability through a system of intelligent network elements that are functionally connected with the SSPs through a network of data links that are commonly designated as 180 in FIG. 1.

These intelligent network elements of the AIN 100 can communicate with each other, and with the SSPs of the network, via digital data messages transmitted over the network of digital data links 180. A SSP may be configured to interface with these intelligent network elements through the use of a “trigger.” In general, a trigger serves as an indicator for the SSP to take certain action. The SSP is configured so that, when the SSP detects a predetermined set of conditions defining the trigger in association with a communication, the SSP creates an appropriate digital data message for transmission over the network of digital data links 180. The SSP may also suspend routing of the communication (i.e., hold the communication) until the SSP receives a reply to its message from an appropriate network element (via the network of digital data links 180) instructing the SSP to take a certain action. If the SSP receives no instructions within a certain amount of time, the SSP may “time-out” and execute a default task for the communication.

The message created by an SSP in response to a trigger is known as a “query” message. A query message opens a “transaction” and the SSP generally holds the communication while the transaction remains open. The reply to the query message may be a “conversation” message or a “response” message. Conversation messages allow for bi-directional exchanges between network elements while the transaction remains open. A “response” message closes the transaction opened by the query message, and usually instructs the SSP to route the held communication for connection with a terminating destination. A trigger is typically activated or deactivated at an SSP by another network element through an “update” message. Query messages, conversation messages, response messages, and update messages are standard types of messages defined by the AIN protocol. The details of the AIN protocol are well known to those skilled in the art.

For the exemplary embodiments of the present invention, the originating switch 110 is shown as a SSP. It is noted, however, that the AIN 100 may also include non-SSP central office switches (not shown). It will be appreciated that a non-SSP switch may initially receive a communication on a telephone line and pass the communication to another switch, such as SSP 110, for further processing. Similarly, in a cellular or wireless network, a mobile telecommunications switching office (“MTSO”) or other receiver/transmitter may initially receive a communication from a cellular telephone or wireless unit and route the communication to another network element, such as SSP 110, for further processing. In this manner, advanced network functions available through the AIN 100 may be provided to wireless devices and to telephone lines that are directly connected to non-SSP switches.

Each switch in the AIN 100 is connected to a signal transfer point (“STP”) via a data link. This arrangement is represented in FIG. 1 by the originating switch 110, which is connected to a STP 120 via a data link 180a. In an exemplary embodiment of the present invention, the STP 120 is a multi-port, high-speed packet switch that is programmed to respond to the routing information in the SS7 protocol and route the packet to its destination. Digital data messages flowing between the SCP 130 and the SSPs 110, 112, and 114 go through STP 120. Thus, the STP 120 is not normally the destination of a message, but merely directs traffic among the other entities on the network that generate and respond to the data messages.

In an exemplary embodiment of the present invention, much of the intelligence of the AIN 100 resides in a plurality of service control points (“SCPs”) represented by an SCP 130, which is connected to the STP 120 by an SS7 data link 180d. An SCP, such as the SCP 130, is a remotely programmable intelligent network element. As is known to those skilled in the art, SCPs are physically implemented by relatively powerful, fault tolerant computers. Among the functions performed by SCPs is the maintenance of network databases, such as database 150, which is used in providing customers of the telephone network with advanced network functions.

Additional devices for implementing advanced network functions within the AIN 100 are provided by a service management system (“SMS”) 140. The SMS 140 is connected via a data link 180e to the SCP 130. The SMS 140 provides a centralized platform for remotely programming the SCP 130 so that a coordinated information-processing scheme may be implemented for the AIN 100. In an exemplary embodiment of the present invention, the SMS 140 is implemented by a large general-purpose computer and interfaces to business offices of the local exchange carrier and inter-exchange carriers. The functions of the SMS 140 may include: (a) downloading information to the database 150 when new customers are added or when customers modify their ensemble of services; (b) performing data reloads when the SCP 130 crashes or when software needs to be updated; (c) implementing high volume routing services, such as call forwarding and 800 number translation and routing; (d) maintaining and providing access to high volume databases for the authorization of billing, such as credit card number validations; and (e) downloading, on a non-real-time basis, billing information that is needed in order to appropriately invoice telephone company customers for the services provided.

As illustrated in FIG. 1, the AIN 100 also includes a service node (“SN”) 160, which may also be referred to as a service circuit node (“SCN”). The SN 160 includes voice and dual tone multi-frequency (“DTMF”) signal recognition devices and voice synthesis devices. The SN 160 communicates with the SCP 130 via a data link 180f using, for example, X.25 or TCP/IP protocols, and to the SMS 140 via a data link 180g. In addition, the SN 160 typically is connected to one or more (but usually only a few) SSPs via Integrated Service Digital Network (“ISDN”) links, as shown by the connection 161 to the SSP 114.

The AIN 100 thus provides customers with a selectable menu of advanced network functions. These advanced network functions are typically sold on a per-service basis, or in groups of services known as calling plans. Each customer may select a set of advanced network functions, or a calling plan that suits the customer's needs. Moreover, each customer may generally select among a plurality of local advanced network functions, as well as select among a plurality of long distance advanced network functions. One such advanced network function consistent with embodiments of the present invention provides a method for converting a voice message to a text message and delivering the text message to a called party.

In one exemplary embodiment of the present invention, a customer may initiate such an advanced network function by subscribing to a text message forwarding service in accordance with aspects of the present invention. With this subscription, the customer may provide certain information that is stored and maintained in a database, such as database 150. In one embodiment of the present invention, that information may include one or more alternate destinations and their corresponding routing information. An alternate destination may comprise any device capable of accepting a text message, such as a cellular telephone, pager, facsimile machine, electronic mail device, modem, and the like. The corresponding routing information may comprise the directory number generally associated with each provided communication device. In addition, routing information may also comprise the formatting information particular to each type of device.

It should be appreciated that by subscribing to such a service, a customer may select the customer's most commonly monitored device(s) in order to ensure that any messages are promptly received. Thus, the customer may activate and deactivate PINs to create distinct lists of alternate destinations. In addition, the customer may modify the list of alternate destinations without the use of PINs by merely adding and deleting alternate destinations. It should be appreciated that, by allowing a called party to subscribe to this service, the service may be billed directly to the customer instead of the calling party.

In another embodiment of the present invention, the calling party selects an alternate destination and provides the routing information to the chosen alternate destination.

It should be appreciated that the present invention is not limited to the operating environment configuration shown in FIG. 1. Rather, FIG. 1 shows an illustrative portion of the PSTN sufficient to describe the exemplary embodiments of the invention. Many other network elements and interconnections, including SSP, non-SSP, MTSO switches for servicing other pieces of terminating equipment, are not shown in FIG. 1, but will be understood to be appropriate for use with embodiments of the present invention.

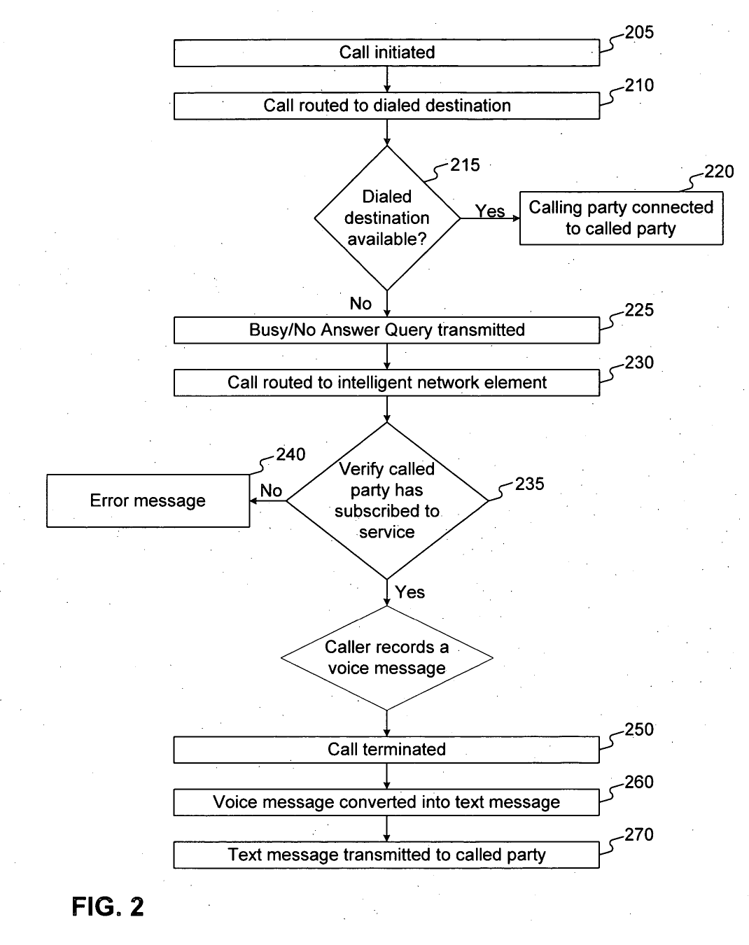

Referring now to FIGS. 1 and 2, a flow chart of method 200 for routing a voice message in accordance with exemplary embodiments of the present invention is illustrated. Method 200 begins at stage 205, where a calling party initiates a call from a terminating device, such as telephone 111a to another terminating device (associated with a called party), such as telephone 115a. In one embodiment of the present invention, the calling party may initiate a call by dialing a conventional seven or ten digit directory number.

At stage 210, the call is routed to the terminating device 115a associated with the dialed directory number via the AIN 100. For example, in one embodiment of the present invention, the call is routed from SSP 111 to SSP 114 based on instructions received from the SCP 130. SSP 114 then rings the terminating device 115a associated with the called party.

At stage 215, the SSP 114 determines whether the telephone line 175a associated with terminating device 115a is available (i.e., answered). If so, method 200 proceeds to stage 220, where the calling party is connected to the called party. If, on the other hand, the SSP 114 determines the line is unavailable (e.g., the telephone line is busy or unanswered), method 200 continues to stage 225, where SSP 114 transmits a query to the SCP 130 via the STP 120 based on a AIN0.2 Busy/NoAnswer trigger.

At stage 230, the SCP 130 receives the query from the SSP 114 and instructs the SSP 114 to route the call to an intelligent network element such as the SN 160. In accordance with one exemplary embodiment of the present invention, the called party has previously subscribed to a text message forwarding service in accordance with aspects of the present invention. Thus, at stage 235, the call is routed to the SN 160, where the SN 160 determines whether the called party previously subscribed to such a service by, for example, searching a database, such as database 150, for a valid subscription associated with the dialed directory number and called party. In one embodiment of the present invention, a valid subscription number may comprise the dialed directory number. It should be appreciated, however, that aspects of the present invention may be practiced without the use of subscriptions.

If the SN 160 determines that the called party has not activated this service, then method 200 branches to stage 240, where the SSP 110 is instructed to return an error message, such as a prerecorded message or a busy signal. It should be appreciated that verification of a valid subscription may alternatively be performed by any intelligent network element, such as the SCP 130. If, on the other hand, the called party has initiated a valid subscription, then method 200 proceeds to stage 245, where the SN 160 records a voice message provided by the calling party.

Based on the calling party's input, the SN 160 obtains the routing and formatting information associated with the chosen destination(s). In accordance with an exemplary embodiment of the present invention, after receiving this information, the communication between the SN 160 and the calling party is terminated at stage 250.

At stage 265, the SN 160 converts the voice message into a text message via a voice recognition program 165. The details of voice, recognition are familiar to those skilled in the art. In addition, the SN 160 formats the message appropriately based on the subscriber selected alternate destinations.

At stage 270, the SN 160 instructs the SSP 114 to route the text message to the selected destination(s). It should be appreciated that if one or more of the selected alternate destinations is unavailable, stage 270 may be repeated until the text message is delivered.

While the exemplary method has been described with respect to an AIN telephone system, those skilled in the art will appreciate that this method could be simply implemented on any number of types of telephone networks.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

Moreover, although the present invention has been described above as implemented in exemplary application program modules, it will be understood that alternative embodiments will become apparent to those skilled in the art to which the present invention pertains without departing from its spirit and scope. Accordingly, the scope of the present invention is defined by the appended claims rather than the foregoing description.

1. A method of routing a text message to a second destination associated with a called party where a first destination is unavailable comprising the steps of:
receiving a call to the first destination associated with a called party initiated by a calling party, wherein the first destination is unavailable;
based on the unavailability of the first destination, requesting a voice message from the calling party;
receiving the voice message provided by the calling party;
converting the voice message into a text message based on determining an appropriate text format required by the second destination; and
forwarding the text message to the second destination associated with the called party, wherein the second destination can be any one of a plurality of communications devices.

2. The method of claim 1, wherein the plurality of communication devices are capable of receiving text messages.

3. The method of claim 2, wherein the plurality of communication devices can be any one of a paging device, a mobile telephone, an electronic mail device, a facsimile machine, a modem, or a computer.

4. The method of claim 1, further comprising the step of receiving additional information from the calling party.

5. The method of claim 4, wherein the additional information comprises routing information of the second destination associated with the called party.

6. The method of claim 4, wherein the additional information comprises an identification of the calling party.

7. The method of claim 1, wherein the requesting step is performed in response to a Busy/No Answer trigger.

8. The method of claim 1, further comprising the step of receiving routing information of the second destination from the called party.

9. The method of claim 1, further comprising the step of disconnecting the calling party after receiving the voice message provided by the calling party.

10. (Canceled).

11. The method of claim 1, further comprising the step of receiving a personal identification number, wherein the personal identification number determines which one of the plurality of alternate destinations comprises the second destination.

12. A system for routing a text message to a second destination associated with a called party where a first destination is unavailable comprising:
a first switch for receiving a call to a first destination associated with a called party initiated by a calling party, wherein the first destination is unavailable;
a network element, coupled to the first switch, for requesting a voice message from the calling party based on the unavailability of the first destination and receiving the voice message provided by the calling party;
a voice recognition means, coupled to the network element, for converting the voice message to a text message based on determining an appropriate text format required by the second destination; and
a second switch, coupled to the network element, wherein the network element forwards the text message to a second destination associated with the called party via the second switch, wherein the second destination can be any one of a plurality of communications devices.

13. The system of claim 12, wherein the network element comprises a service node.

14. The system of claim 12, wherein the second destination is communication device capable of receiving text messages.

15. The system of claim 14, wherein the communication device can be any one of a paging device, a mobile telephone, an electronic mail device, a facsimile machine, a modem, or a computer.

16. The system of claim 12, wherein the network element further performs the function of receiving additional information from the calling party.

17. The system of claim 16, wherein the additional information comprises an identification of the calling party.

18. The system of claim 16, wherein the additional information comprises routing information of the second destination associated with the called party.

19. The system of claim 12, further comprising a memory coupled to the network element, wherein the network element receives routing information of the second destination from the called party and stores the routing information in the memory.

20. The method of claim 12, wherein the network element disconnecting disconnects the calling party after receiving the voice message provided by the calling party.

21. (Canceled).
